(19) United States
(12) Patent Application Publication
(10) Pub. No.: US 2026/0040156 A1
(43) Pub. Date: Feb. 5, 2026

(54) L1/L2 TRIGGERED MOBILITY (LTM) SUPPORT FOR NON-TERRESTRIAL NETWORKS (NTNS)

(71) Applicant: InterDigital Patent Holdings, Inc., Wilmington, DE (US)

(72) Inventors: Brian Martin, Farnham (GB); Dylan Watts, Montreal (CA); Oumer Teyeb, Montreal (CA); Umer Salim, Vallauris (FR); Keiichi Kubota, Tokyo (JP); Moon-il Lee, Melville, NY (US)

(73) Assignee: InterDigital Patent Holdings, Inc., Wilmington, DE (US)

(21) Appl. No.: 18/794,888

(22) Filed: Aug. 5, 2024

(51) Int. Cl. H04W 36/00; H04W 36/24; H04W 36/32

(52) U.S. Cl. CPC H04W 36/0061; H04W 36/0058; H04W 36/249; H04W 36/32

(57) ABSTRACT

A wireless transmit/receive unit (WTRU) may receive radio resource control (RRC) configuration information. The WTRU may receive measurement configuration information including a beam level measurement condition associated with the NTN candidate cell and at least one measurement event condition. The WTRU may trigger an LTM event based on the beam level measurement condition and the at least one measurement event condition being satisfied. The WTRU may receive an indication to perform location-based pre-compensation associated with the NTN candidate cell. The WTRU may determine a first timing advance (TA) value associated with the NTN candidate cell based on the location-based timing pre-compensation. The WTRU may receive an indication to perform LTM to the NTN candidate cell. The WTRU may perform the LTM and may transmit a handover completion message to the NTN candidate cell.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, devices, and instrumentalities are described herein related to L1/L2 triggered mobility (LTM) support for non-terrestrial networks (NTNs).

A wireless transmit/receive unit (WTRU) may receive radio resource control (RRC) configuration information. The RRC configuration information may include an indication (e.g., a first indication) of a cell type being a non-terrestrial network (NTN) candidate cell and associated ephemeris information or further associated ephemeris information. In examples, the RRC configuration information may include an indication (e.g., a fourth indication) that may configure a TA acquisition type as the location-based timing pre-compensation. In examples, the RRC configuration information may include an indication (e.g., a fifth indication) of a satellite architecture type. The WTRU may receive measurement configuration information. The measurement configuration information may include a beam level measurement condition for the NTN candidate cell and at least one measurement event condition associated with the NTN candidate cell. The at least one measurement event condition may include at least one of a time-based triggering condition or a distance-based triggering condition.

The WTRU may trigger an LTM event. The LTM event may be triggered based on the beam level measurement condition and the at least one measurement event condition being satisfied. The WTRU may perform an action based on the LTM event being triggered. The action performed may be at least one of: a transmission of a measurement report using a medium access control (MAC) control element (CE) or a physical uplink control channel (PUCCH) that indicates the at least one measurement event condition being satisfied; a determination of the TA value for the NTN candidate cell using an early synchronization procedure; a performance of a conditional LTM to the NTN candidate cell; or a determination to perform an update associated with the NTN candidate cell. The update associated with NTN candidate cell may be used to perform at least one of: enabling or disabling a measurement; releasing a configuration of the NTN candidate cell; or enabling or disabling the at least one measurement event condition.

The WTRU may receive an indication (e.g., a second indication) to perform location-based pre-compensation for the NTN candidate cell. In examples, the second indication to perform location-based timing pre-compensation for the NTN candidate cell may be based on at least one measurement event condition being met. In examples, the second indication to perform location-based timing pre-compensation for the NTN candidate cell may indicate (e.g., in a MAC CE) a time to apply a cell switch and to calculate the TA value based on the time. The WTRU may determine a first timing advance (TA) value for the NTN candidate cell based on the location-based timing pre-compensation.

The WTRU may receive an indication (e.g., a third indication) to perform LTM to the NTN candidate cell. In examples, the third indication to perform LTM to the NTN candidate cell may be based on at least one measurement event condition being met. The WTRU may perform the LTM to the NTN candidate cell and transmit, using a TA value, a handover completion message to the NTN candidate cell. In examples, the handover completion message may be an RRC reconfiguration complete message. In examples, the performance of the LTM to the NTN candidate cell may include an execution of a handover to the NTN candidate cell. In examples, the TA value may be a first TA value. Based on the first TA value for the NTN candidate cell being valid, the WTRU may transmit a handover completion message to the NTN candidate cell using the first TA value. Based on the first TA value for the NTN candidate cell being invalid, the third indication may indicate a second TA value to use and the WTRU may transmit a handover completion message to the NTN candidate cell using the second TA value. The WTRU may indicate a completion of a TA acquisition to a source cell. The WTRU may determine a validity time associated with the first value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example LTM procedure.

FIG. 3 illustrates an example of transparent architecture.

FIGS. 4-5B illustrate example regenerative payload architectures

FIG. 6 illustrates an example of regenerative payload architecture.

### DETAILED DESCRIPTION

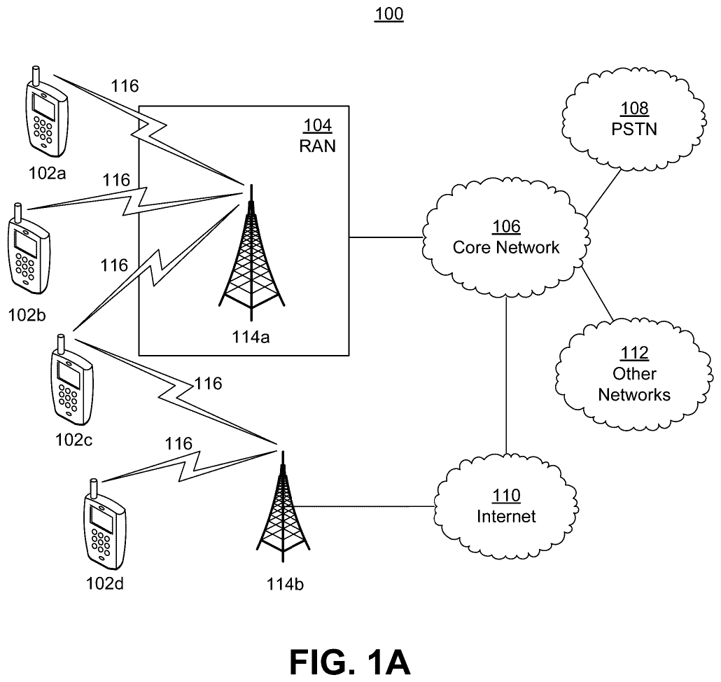

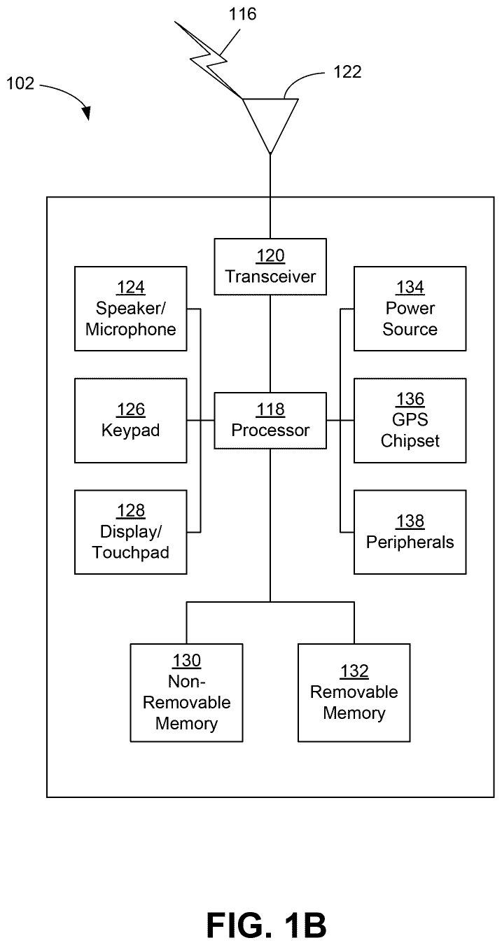

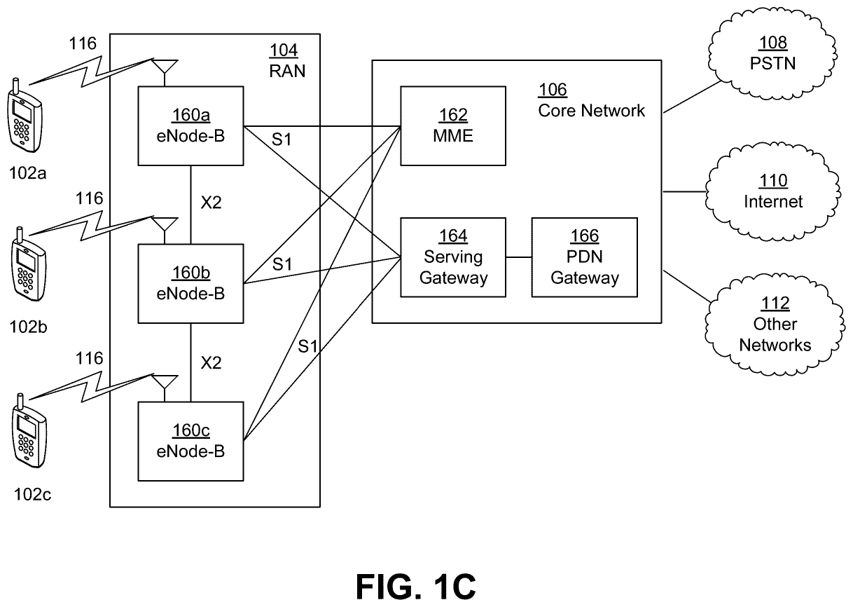

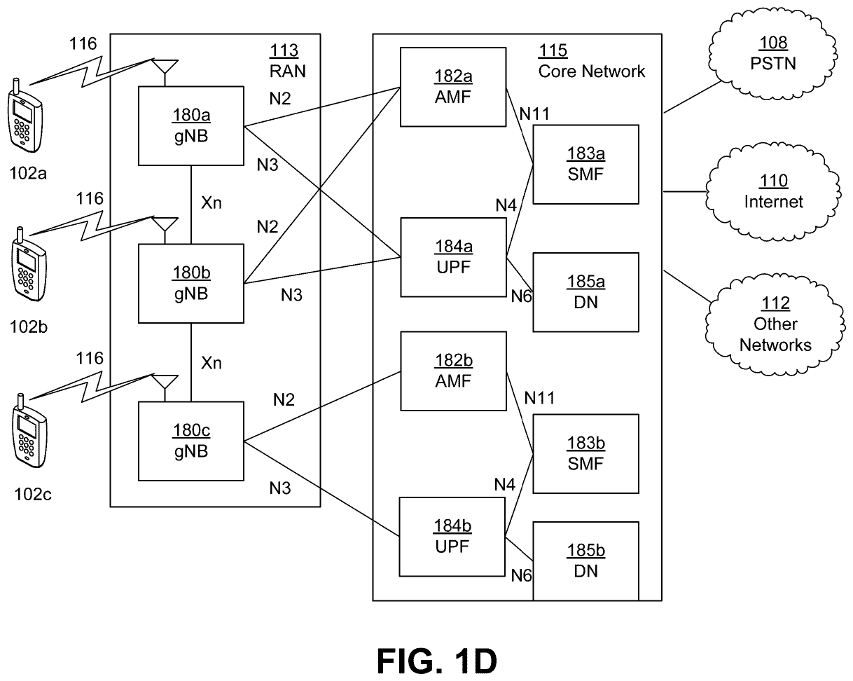

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc.

Systems, methods, devices, and instrumentalities are described herein related to L1/L2 triggered mobility (LTM) support for non-terrestrial networks (NTNs).

A wireless transmit/receive unit (WTRU) may receive radio resource control (RRC) configuration information. The RRC configuration information may include an indication (e.g., a first indication) of a cell type being a non-terrestrial network (NTN) candidate cell and associated ephemeris information or further associated ephemeris information. In examples, the RRC configuration information may include an indication (e.g., a fourth indication) that may configure a TA acquisition type as the location-based timing pre-compensation. In examples, the RRC configuration information may include an indication (e.g., a fifth indication) of a satellite architecture type. The WTRU may receive measurement configuration information. The measurement configuration information may include a beam level measurement condition for the NTN candidate cell and at least one measurement event condition associated with the NTN candidate cell. The at least one measurement event condition may include at least one of a time-based triggering condition or a distance-based triggering condition.

The WTRU may trigger an LTM event. The LTM event may be triggered based on the beam level measurement condition and the at least one measurement event condition being satisfied. The WTRU may perform an action based on the LTM event being triggered. The action performed may be at least one of: a transmission of a measurement report using a medium access control (MAC) control element (CE) or a physical uplink control channel (PUCCH) that indicates the at least one measurement event condition being satisfied; a determination of the TA value for the NTN candidate cell using an early synchronization procedure; a performance of a conditional LTM to the NTN candidate cell; or a determination to perform an update associated with the NTN candidate cell. The update associated with NTN candidate cell may be used to perform at least one of: enabling or disabling a measurement; releasing a configuration of the NTN candidate cell; or enabling or disabling the at least one measurement event condition.

The WTRU may receive an indication (e.g., a second indication) to perform location-based pre-compensation for the NTN candidate cell. In examples, the second indication to perform location-based timing pre-compensation for the NTN candidate cell may be based on at least one measurement event condition being met. In examples, the second indication to perform location-based timing pre-compensation for the NTN candidate cell may indicate (e.g., in a MAC CE) a time to apply a cell switch and to calculate the TA value based on the time. The WTRU may determine a first timing advance (TA) value for the NTN candidate cell based on the location-based timing pre-compensation.

The WTRU may receive an indication (e.g., a third indication) to perform LTM to the NTN candidate cell. In examples, the third indication to perform LTM to the NTN candidate cell may be based on at least one measurement event condition being met. The WTRU may perform the LTM to the NTN candidate cell and transmit, using a TA value, a handover completion message to the NTN candidate cell. In examples, the handover completion message may be an RRC reconfiguration complete message. In examples, the performance of the LTM to the NTN candidate cell may include an execution of a handover to the NTN candidate cell. In examples, the TA value may be a first TA value. Based on the first TA value for the NTN candidate cell being valid, the WTRU may transmit a handover completion message to the NTN candidate cell using the first TA value. Based on the first TA value for the NTN candidate cell being invalid, the third indication may indicate a second TA value to use and the WTRU may transmit a handover completion message to the NTN candidate cell using the second TA value. The WTRU may indicate a completion of a TA acquisition to a source cell. The WTRU may determine a validity time associated with the first value.

Examples of enabling mobility controlled by the distributed unit (DU) on board a satellite by optimizing LTM for NTN are provided herein. LTM based L1 measurement reporting and/or conditional LTM may be enabled by introducing time and location-based events to the beam level L1 reporting/evaluation framework. A WTRU may be enabled to perform location-based NTN timing pre-compensation to support early uplink synchronization for random access channel (RACH)-less LTM using RRC semi-static configuration. The WTRU may dynamically indicate when to perform procedure using MAC CE/PDCCH order.

LTM is a procedure in which a gNB may receive L1 measurement report(s) from a WTRU. Based on the L1 measurement report(s), the gNB may change the WTRU serving cell by a cell switch command signaled (e.g., via a MAC CE). The cell switch command may indicate an LTM candidate configuration that the gNB previously prepared and provided to the WTRU through RRC signaling. The WTRU may (e.g., may then) switch to the target configuration according to the cell switch command. The LTM procedure may be used to reduce the mobility latency as described in examples herein.

If configured by the network, it may be possible to activate transmission configuration indicator (TCI) states of one or multiple cells that are different from the current serving cell. For instance, the TCI states of the LTM candidate cells may be activated in advance before any of those cells become the serving cell. This may allow the WTRU to be downlink (DL) synchronized with those cells. This may facilitate a faster cell switch to one of those cells if a cell switch is triggered.

If configured by the network, it may be possible to initiate uplink (UL) TA acquisition (e.g., early TA) procedure of one or multiple cells that are different from the current serving cells. If the cell has the same NTA as the current serving cells or NTA=0, early TA acquisition procedure may not be required. The network may request the WTRU to perform early TA acquisition of a candidate cell before a cell switch. The early TA acquisition procedure may be triggered by a physical downlink control channel (PDCCH) or realized through WTRU-based TA measurement (e.g., as configured by RRC). In the former case, the gNB to which the candidate cell belongs may calculate the TA value and may send the TA value to the gNB to which the serving cell belongs. The serving cell may send the TA value in the LTM cell switch command MAC CE if triggering an LTM cell switch. In the latter case, the WTRU may perform a TA measurement for the candidate cells after being configured by RRC but the exact time the WTRU performs the TA measurement is up to WTRU implementation. The WTRU may apply the TA value measured by itself and may perform RACH-less LTM if receiving the cell switch command. The network may (e.g., may also) send a TA value in the LTM cell switch command MAC CE without early TA acquisition.

Depending on the availability of a valid TA value, the WTRU may perform either a RACH-less LTM or RACH-based LTM cell switch. If the TA value is provided in the cell switch command, the WTRU may apply the TA value as instructed by the network. If the WTRU-based TA measurement is configured, but no TA value is provided in the cell switch command, the WTRU may apply the TA value by itself (e.g., if available). Meanwhile, the WTRU may perform a RACH-less LTM cell switch if receiving the cell switch command. If no valid TA value is available, the WTRU may perform a RACH-based LTM cell switch.

Regardless of whether the WTRU is configured for WTRU-based TA measurement for a certain candidate cell, the WTRU may still follow the PDCCH order, which may include requesting a random-access procedure towards the candidate cells. This may (e.g., may also) apply to the candidate cells for which the WTRU is capable of deriving TA values by itself. Regardless of whether the WTRU has already performed a random-access procedure towards the candidate cells, it may (e.g., may also) still follow the WTRU-based measurement configuration (e.g., if configured by the network).

For RACH-less LTM, the WTRU may access the target cell (e.g., NTN candidate cell) using either a configured grant or a dynamic grant. The configured grant may be provided in the LTM candidate configuration, and the WTRU may select the configured grant occasion associated with the beam indicated in the cell switch command. If the LTM cell switch is initiated to the target cell, the WTRU may start to monitor PDCCH on the target cell for dynamic scheduling. Before RACH-less LTM procedure completion, the WTRU may not trigger a random-access procedure if it the WTRU not have a valid physical uplink control channel (PUCCH) resource for triggered scheduling requests (SRs).

The following principles may apply to LTM: a security key may be maintained if an LTM cell switched; and/or a subsequent LTM may be supported.

LTM may support both intra-gNB-DU and intra-gNB-CU inter-gNB-DU mobility. LTM may support both intra-frequency and inter-frequency mobility, including mobility to inter-frequency cell that is not a current serving cell. LTM may be supported (e.g., supported only) for a licensed spectrum. At least one of following scenarios may be supported: a PCell change in a non-CA scenario and a non-DC scenario; a PCell and SCell(s) change in a carrier aggregation (CA) scenario; or a dual connectivity scenario. In the dual connectivity connection, PCell and master cell group (MCG) SCell(s) may change and intra-SN PSCell and secondary cell group (SCG) SCell(s) may change without MN involvement. LTM for simultaneous PCell and PSCell change may not be supported.

While the WTRU has stored LTM candidate configurations, the WTRU may (e.g., may also) execute any L3 handover command sent by the network.

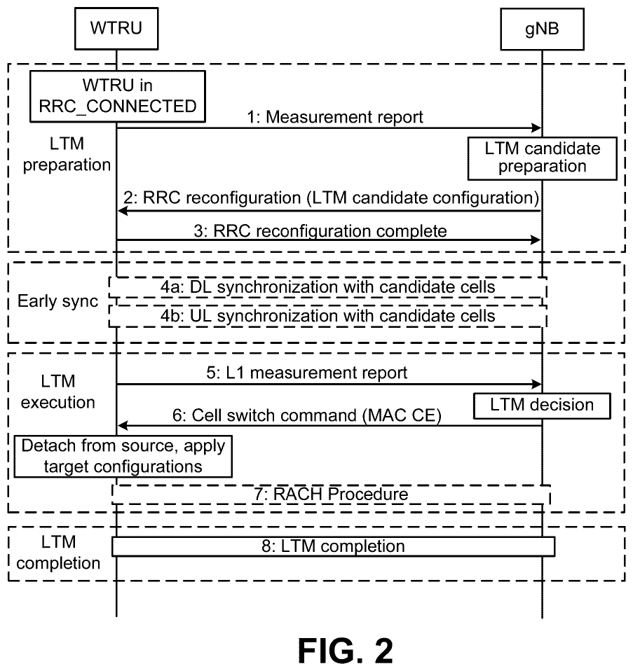

FIG. 2 illustrates an example LTM procedure. Event triggered L1 measurement(s) (e.g., beam level measurement condition(s) may be designed for at least one of the following LTM purposes: selecting the candidate beam/cell to trigger early synchronization; and/or selecting the target beam/cell and trigger LTM cell switch procedure. For an event triggered L1 measurement, a beam level measurement result for an event evaluation may be used as a baseline. In examples, other measurements may be used for the cell level measurement.

Measurement events (e.g., beam level measurement condition(s) supporting at least one of the following LTM events based on beam specific quality of serving cell and candidate cells as the L1 LTM measurement events may be provided: event LTM2 where the beam of a serving cell becomes worse than absolute threshold; event LTM3 where the beam of a candidate cell becomes amount of offset better than beam of serving cell; event LTM4 where the beam of a candidate cell becomes better than an absolute threshold; event LTM5 where the beam of a serving cell becomes worse than an absolute threshold1 and a beam of a candidate cell becomes better than another absolute threshold2; what beam(s) of the serving cell and neighboring cell may be used for event evaluation; or the need of an event LTM1.

Measurement events supporting the beam configuration of both synchronization signal block (SSB) and channel state information reference signal (CSI-RS) in an L1 measurement resource configuration in LTM configuration may be provided. The same reference signal (RS) type may be used for both serving and neighboring cells for an event LTM3 and an event LTM5. RAN2 may assume filtering of the L1 measure results as needed. The RAN1 may decide whether the specified L1 filtering is needed or to leave it to WTRU implementation.

For LTM event evaluation, time to trigger (TTT), hysteresis for entering/leaving, and/or beam specific (e.g., cell specific) offset may be applied. Examples associated with the need of measurement reporting once the leaving condition is met may be provided.

Examples of Non-Terrestrial Networks (NTNs) are provided herein. An NTN may include an aerial or space-borne platform which, via a gateway (GW), transports signals from a land-based based gNB to a WTRU and vice-versa. Aerial or space-borne platforms may be classified in terms of orbit, with non-geosynchronous orbit (NGSO) satellites including low-earth orbit (LEO) with an altitude range of 300-1500 km and medium-earth orbit (MEO) satellites with an altitude range 7000-25000 km. NGSO satellites may move continuously overhead relative to earth, whereas geosynchronous orbit (GSO) satellites may remain fixed overhead by maintaining an altitude at 35 786 km.

Satellite platforms may be further classified as having a transparent or regenerative payload. Transparent satellite payloads may implement frequency conversion and RF amplification in both uplink and downlink, with multiple transparent satellites possibly connected to one land-based gNB. Regenerative satellite payloads may implement either a full gNB or gNB DU onboard the satellite. Regenerative payloads may perform digital processing on the signal including demodulation, decoding, re-encoding, re-modulation and/or filtering.

An NTN satellite may support multiple cells, where the cells (e.g., each cell) may include one or more satellite beams. Satellite beams may cover a footprint on earth (like a terrestrial cell) and may range in diameter from 100-1000 km in NGSO deployments, and 200-3500 km diameter in GSO deployments. Beam footprints in GSO deployments may remain fixed relative to earth, and in NGSO deployments, the area covered by a beam/cell may change over time due to satellite movement. This beam movement may be classified as earth moving where the NGSO beam moves continuously across the earth, or earth fixed where the beam may be steered to remain covering a fixed location until a new cell overtakes the coverage area in a discrete and coordinated change.

The key challenges of non-terrestrial networks may include one of more of: continuous movement of NGSO satellites overhead resulting in frequent and continuous cell change; cell sizes up to 3500 km in diameter; or round-trip times (RTT) several orders of magnitude larger than terrestrial networks (e.g., up to 541.46 ms). The WTRU may compensate for such delay by performing a location-based timing pre-compensation procedure, where the WTRU may acquire satellite assistance information (e.g., such as the feeder-link delay and satellite location). The WTRU may (e.g., may also) acquire WTRU location information (e.g., via GNSS), and using the satellite location may calculate the service link delay. The WTRU may (e.g., may then) add the service link delay to the feeder-link delay to obtain the full RTT estimate to be used for TA pre-compensation.

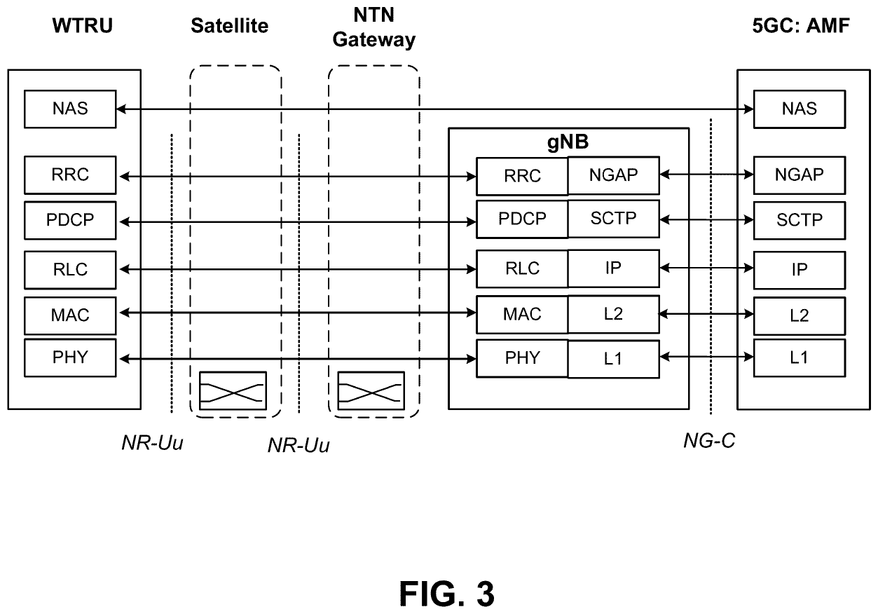

FIG. 3 illustrates an example of transparent architecture. A satellite may act as a simple relay capable (e.g., capable only) of amplification and frequency shifting. In transparent payload deployment, the satellite may relay signaling from the WTRU to a ground-based gNB via a gateway The architecture may be inefficient from a latency and routing perspective as the WTRU-gNB RTT may include both the WTRU-satellite and satellite-gNB delay (e.g., which may be up to 500 ms).

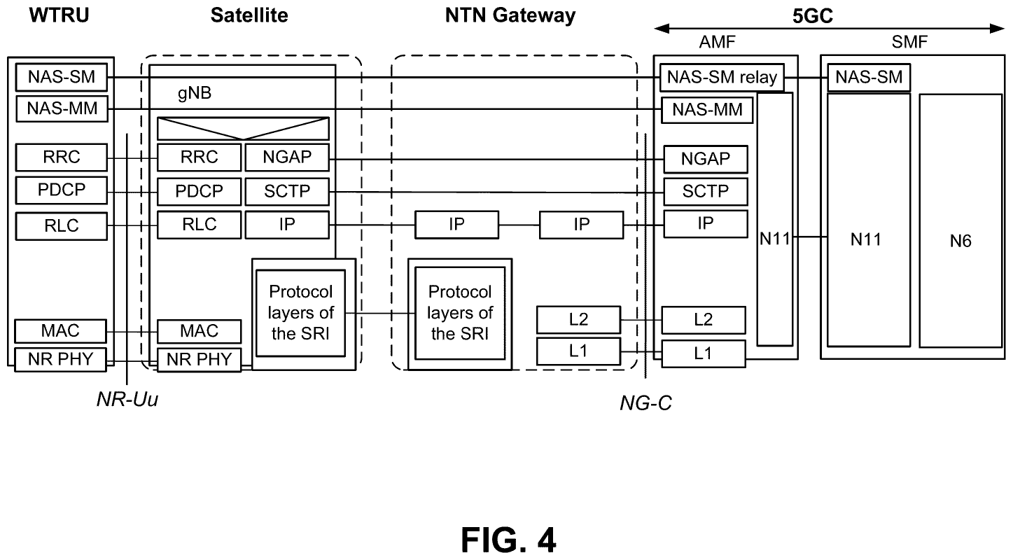

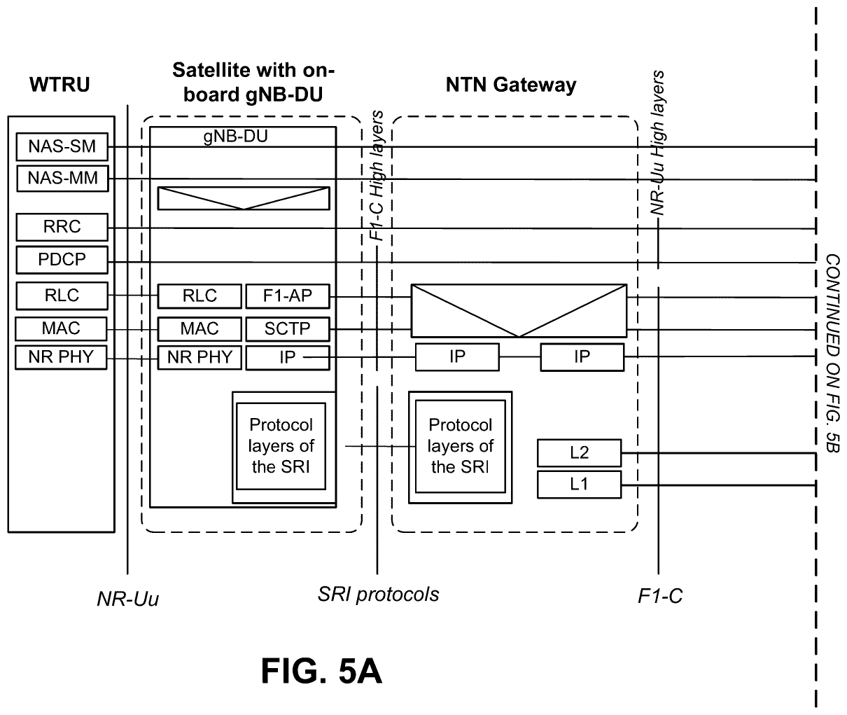

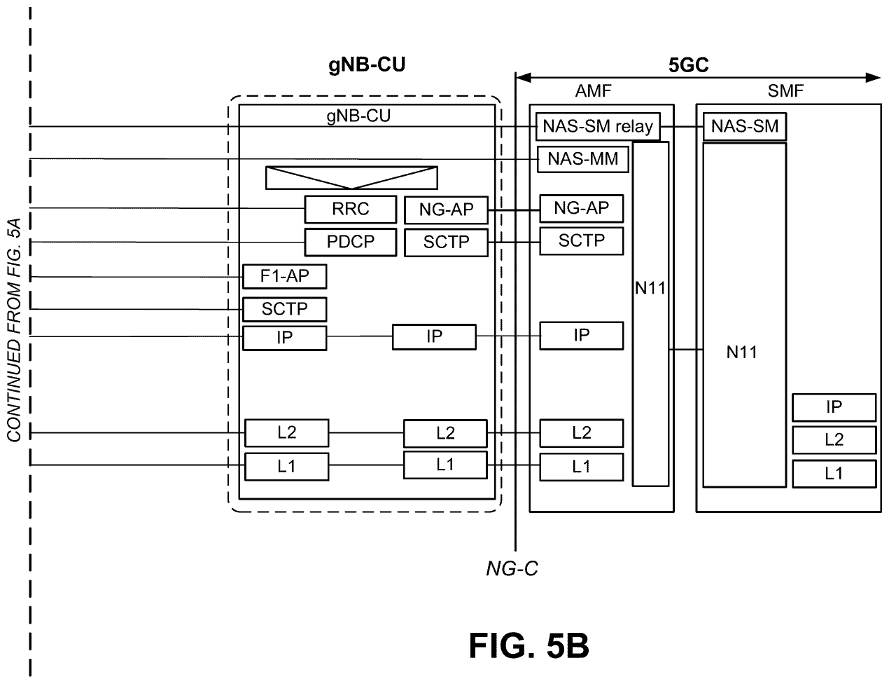

FIGS. 4-5B illustrate example regenerative payload architectures (e.g., satellite architecture types). Examples of supporting of regenerative payload are provided. Support for a regenerative payload where at least some gNB functionality may be located on the satellite may be provided. The regenerative payload may be beneficial from a latency perspective and may allow flexibility of routing to a specific feeder-link and support for simultaneous connection to multiple core networks per country. As shown in FIG. 4, a full gNB on board may be provided. As shown in FIG. 5, a gNB-DU onboard with a CU located on the ground may be provided.

Mobility for regenerative payload NTN architecture may be improved by enabling LTM optimized for NTN. Enabling LTM for NTN may allow the DU to control mobility (e.g., receive L1 reports, issue cell switch command). LTM may be well suited to an NTN environment for the following reasons. LTM may be well suited to an NTN environment because the LTM signaling/measurements may not go all the way to CU. Some may terminate at a DU which may reduce handover (HO) procedure delay. This may be a key issue considering the large RTT in non-terrestrial networks (e.g., especially if combined with RACH-less HO). LTM may be well suited to an NTN environment because the NTN may have a robust timing pre-compensation procedure. This may help in the estimation of timing advance pre-calculation. The LTM may be well suited to an NTN environment because considering the deterministic nature of satellite movement, the upcoming cell may be known to the network. This may support accurate pre-configuration of LTM candidates, accurate conditional LTM execution, and/or accurate measurement reporting triggering.

The LTM may be even better suited for a CU-DU split since LTM is DU-controlled mobility. This may lower latency mobility without interaction from the ground-based CU. Examples of utilizing NTN timing pre-compensation procedure for a RACH-less LTM in NTN are provided herein. Examples of how to leverage the predictable satellite movement characteristic of NTN and enable time and location based LTM triggers (e.g., for both network controlled and conditional LTM) are provided herein.

Examples of LTM in NTNs are provided herein. Examples of enabling mobility controlled by the DU on board a satellite by optimizing LTM for NTN are provided herein. LTM based L1 measurement reporting and/or conditional LTM may be enabled by introducing time and location-based events to the beam level L1 reporting/evaluation framework. A WTRU may be enabled to perform location-based NTN configuration. The WTRU may dynamically indicate when to perform procedure using a MAC CE/PDCCH order.

In examples, a WTRU may receive an RRC configuration (e.g., configuration information) of one or more LTM candidate cells. The configuration information may include an indication (e.g., a first indication) of cell type (e.g., an LTM candidate cell type) being an NTN cell. The configuration information may include associated ephemeris information or further ephemeris information (e.g., which may include the LTM candidate cell type being an NTN cell). The configuration information may (e.g., may also) include an indication (e.g., a fourth indication) configuring a TA acquisition type as location-based timing pre-compensation. The configuration information may (e.g., may also) include an indication (e.g., a fifth indication) of a satellite architecture type. Based on the satellite architecture type, a TA estimate may include the WTRU to satellite path (e.g., if full gNB on board), or may include satellite to ground (e.g., transparent architecture).

The WTRU may receive a measurement configuration (e.g., configuration information) including at least one L1 beam level measurement condition associated with the one or more NTN LTM candidate cells. The measurement configuration information may (e.g., may also) include at least one measurement event condition associated with the NTN candidate cell including one or more of the following: an LTM measurement event which uses a time-based triggering condition; or an LTM measurement event which uses a distance-based triggering condition.

The time-based triggering condition may be a time measured at the WTRU that is within a duration from a threshold. The distance-based triggering condition may be the distance between the WTRU and a referenceLocation1 being above a threshold1 and the distance between the WTRU and a referenceLocation2 being below a threshold2. The distance-based triggering condition may be the distance between the WTRU and the serving cell moving reference location being above a threshold1 and distance between the WTRU and a moving reference location being below a threshold2.

The WTRU may trigger an LTM event based on at least one measurement event condition being satisfied (e.g., the time and/or distance-based condition being met) and the beam level measurement condition being satisfied.

Based on the LTM event being triggered, the WTRU may perform an action. The action may include one or more of the following: a transmission of a measurement report using a MAC CE or a PUCCH that indicates at least that at the least one measurement condition being satisfied (e.g., a time/distance/beam measurement condition being met); a determination of the TA value for the NTN candidate cell using an early synchronization procedure; a performance of a conditional LTM to the target cell (e.g., NTN candidate cell); or a determination to update the NTN candidate cell. For the transmission using a MAC CE or a PUCCH that indicates at least that at the least one measurement condition being satisfied (e.g., a time/distance/beam measurement condition being met), the WTRU may (e.g., may then) receive the cell switch MAC CE or the PDCCH order for early UL synchronization.

For the determination of the TA value for the NTN candidate cell using an early synchronization procedure, the WTRU may transmit a RA to a target cell (e.g., NTN candidate cell) and/or may perform location-based timing pre-compensation (e.g., the WTRU may then continue the LTM procedure).

For the performance of the LTM (e.g., performance of the conditional LTM to the NTN target cell), the performance may be RACH-less or RACH based.

For the determination (e.g., based on the time and/or distance-based condition being met) to update the NTN candidate cell (e.g., active NTN LTM candidate cell(s)), updating the NTN candidate cell may be used to perform at least one of: may be used to enable/disable certain measurements/RSs/NTN cells; may be used to release a candidate configuration (e.g., an NTN candidate cell configuration); or may be used to enable or disable a specific measurement event or conditional LTM configuration (e.g., enable or disable at least one measurement event condition).

The WTRU may receive an indication (e.g., a second indication) to perform location-based timing pre-compensation associated with one or more NTN candidate cells. In examples, the indication to perform location-based timing pre-compensation associated with one or more NTN candidate cells may be based on at least one measurement event condition being satisfied. In examples, the indication to perform location-based timing pre-compensation associated with one or more NTN candidate cells may be explicitly triggered. In examples, the indication to perform location-based timing pre-compensation may be indicated via a PDCCH order (e.g., a PDCCH order may be used to trigger a RA to a target cell). In examples, the indication to perform location-based timing pre-compensation may be indicated via a MAC CE (e.g., the TA value may be included within a cell switch MAC CE or may be included within a separate MAC CE). In examples, the indication to perform location-based timing pre-compensation may indicate, in the MAC CE or RRC configuration, a time at which to apply the cell switch and may calculate a TA value according to that time.

The WTRU may determine a TA value (e.g., a first TA value) associated with the indicated NTN candidate cell(s) based on (e.g., using) the location-based timing pre-compensation. In examples, the WTRU may indicate a completion of TA acquisition to source (e.g., using a MAC CE). In examples, the WTRU may determine a validity time for the TA value (e.g., may start a timer).

The WTRU may receive an indication (e.g., third indication) to perform LTM to the NTN candidate cell (e.g., via a cell switch MAC CE). The indication (e.g., third indication) may indicate which TA value to use (e.g., an explicit TA value via a MAC CE or a RRC configured type TA value (e.g., the RRC configuration value may be the TA value associated with the indicated NTN candidate cell(s) based on the location-based timing pre-compensation, if available)). In examples, the indication (e.g., third indication) to perform LTM to the NTN candidate cell may be based on at least one measurement event condition being satisfied. In examples, the indication to perform LTM to the NTN candidate cell associated with one or more NTN candidate cells may be explicitly triggered.

The WTRU may perform the LTM to the NTN candidate cell. In examples, the performance of the LTM to the NTN candidate cell may include an execution of a handover to the NTN candidate cell. Based on the first TA value (e.g., associated with the NTN candidate cell and/or target cell) being valid (e.g., based on timer), the WTRU may transmit a handover completion message (e.g., a RRC reconfiguration complete message on PUSCH) using the first value TA (e.g., the TA value determined using the location-based timing pre-compensation procedure). Based on the first TA value (e.g., associated with the NTN candidate cell and/or target cell) being invalid, the third indication may indicate a second TA value to use and the WTRU may transmit a handover completion message (e.g., an RRC reconfiguration complete message on PUSCH) to the target cell using the second TA value. In examples, the transmission of the handover complete message may be RACH-less using either a configured grant or scheduled grant (e.g., received by monitoring a PDCCH if a cell switch occurs).

Examples herein may allow for DU controlled mobility if a gNB (e.g., either full a gNB or DU only) is on board the satellite in NTN regenerative payload architectures. This may enable better mobility latency because mobility related signaling may not need to be transmitted/received via the feeder link to the network nodes on the ground, significantly reducing signaling delays. Examples herein may enable early uplink synchronization to an NTN cell without requiring RACH transmission. Examples herein may enable RACH-less LTM. Uplink coverage to NTN may be an issue in addition to long transmission delay, and RA may not be reliable requiring several retransmissions (e.g., even if performed at full transmission power). Examples herein may enable time and location-based events to be used in the L1 reporting framework for performing LTM to NTN cells, which may be more suited to NTN environments than reference signal reference power (RSRP) based events, since RSRP may be relatively uniform within an NTN cell.

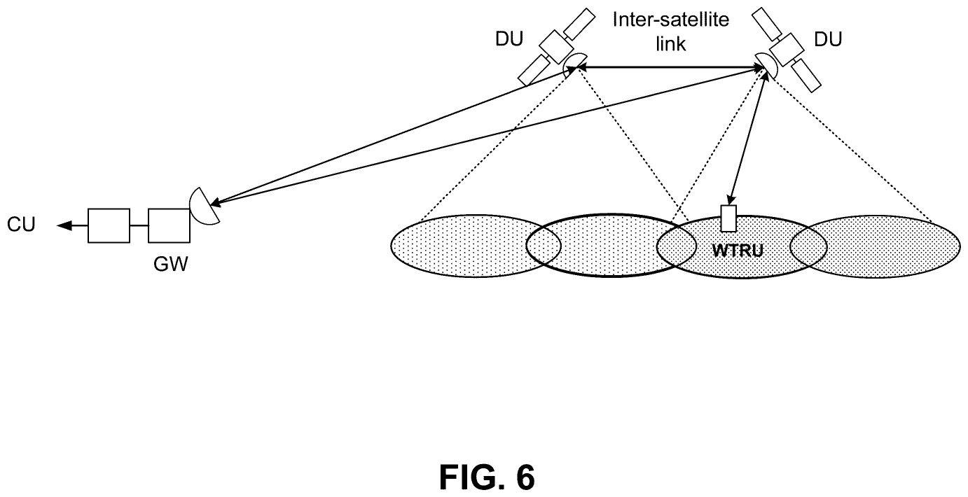

FIG. 6 illustrates an example of regenerative payload architecture (e.g., a satellite architecture type). In examples shown in FIG. 6, LTM may be used to perform DU controlled mobility using LTM, without the need for CU terminated signaling and mobility decisions. This may remove the additional latency caused by transmission of signaling over the feeder (satellite to gateway) link.

Perform LTM or perform LTM procedures may refer to performing any/all of the procedures as shown in FIG. 2. For example, perform LTM or perform LTM procedures may refer to performing early synchronization in DL and/or UL to one or more of the candidate cells, performing L1 measurements and reporting on one or more of the candidate cells, switching (e.g., performing handover) between candidate cells (e.g. perform LTM may mean that the WTRU moves/switches between multiple candidate cells during the procedure).

The one or more candidate cell sets may be groups of more than one RRC configuration corresponding to a handover configuration for one or more candidate SpCells and SCells. This may be modelled or received as one or more complete RRC reconfiguration messages, one or more cell group configurations, or one or more cell configurations. The candidate cell configurations (e.g., each of the candidate cell configurations) may include a candidate configuration identifier, and the candidate cell groups (e.g., each of the candidate cell groups) may include a candidate cell group identifier. If the grouping is performed at RRC, the switching between different sets of candidate cells may include updating the serving cell indexes or candidate configuration indexes which may be used in L1 and MAC signaling to refer to specific indexes (e.g., a MAC CE triggering the reconfiguration may include a candidate configuration index informing the WTRU which cell to perform the reconfiguration to).

The one or more candidate cell groups may be configured as a single list or group of candidate cell configurations at RRC. The grouping may occur at the early synchronization or LTM execution phase rather than the configuration phase. This means the candidate cell set may be considered as a single group in terms of an RRC configuration list or group, while the cells selected for performing early sync, L1 measurements, and LTM execution may depend on a grouping (e.g., a further grouping) into multiple subsets of the overall candidate cell list. The grouping itself may not be modelled at RRC using candidate configuration identifiers, but the grouping may be executed as part of the early synchronization or the LTM execution procedure.

If referring to an LTM candidate configuration, this may apply to any type of preconfigured cell information. For example, a WTRU may be configured with one or more conditional reconfigurations such as conditional handover (CHO), conditional PSCell addition (CPA), or conditional PSCell change (CPC), which may be valid before and/or after a cell change or may be valid in certain cells.

Synchronization Signal Block (SSB) or an SS/PBCH block may include at least one of the following: a Primary Synchronization Signal (PSS), a Secondary Synchronization Signal (SSS), a Physical Broadcast Channel (PBCH) (Data, MIB), or a PBCH (DMRS). The SSBs may be transmitted by the network node (e.g., base station, TRP, relay node, RIS unit) in different directions as beams. The number of SSB beams in an SSB burst set, which may be transmitted periodically within an interval (e.g. 5 ms), may depend on the carrier frequency. For example, an SSB burst may include 4 SSBs for FR1 (<3 GHz), 8 SSBs for FR1 (3 to 6 GHz) and 64 SSBs for FR2. Certain SSBs may be transmitted as on-demand SSBs (OD-SSBs), which may possibly include a subset of SSBs in a burst. Such OD-SSBs may be transmitted aperiodically, semi-persistently, or periodically with certain periodicity. The transmission of such OD-SSBs may be triggered by the network node or WTRU (e.g., via transmission of an UL WUS). Some SSBs may include slim/lean SSBs, which may include PSS only, PSS and SSS-only, PBCH, or a subset of MIB-only.

Channel state information reference signal (CSI-RS) may include at least one of the following: a CSI-RS resource set (ID), a CSI-RS resource (ID/index), resource mapping, power control offset values (e.g., with respect to PDSCH, SSB), a scrambling ID, periodicity, or offset and QCL information. CSI-RS may be transmitted in DL by the network node as CSI-RS beams (e.g., via different resource types including periodic, semi-persistent, and aperiodic).

Channel state information (CSI) may include at least one of the following: a channel quality index (CQI), a rank indicator (RI), a precoding matrix index (PMI), an L1 channel measurement (e.g., RSRP such as L1-RSRP, or SINR), a CSI-RS resource indicator (CRI), an SS/PBCH block resource indicator (SSBRI), a layer indicator (LI), or any other measurement quantity measured by the WTRU from the configured CSI-RS or SS/PBCH (SSB) block.

Channel conditions may be any conditions relating to the state of the radio/channel, which may be determined by the WTRU from: a WTRU measurement (e.g., L1/SINR/RSRP, CQI/MCS, channel occupancy, RSSI, power headroom, exposure headroom), L3/mobility-based measurements (e.g. RSRP, RSRQ, s-measure), an RLM state, and/or channel availability in unlicensed spectrum (e.g., whether the channel is occupied based on determination of an LBT procedure or whether the channel is deemed to have experienced a consistent LBT failure).

An L1 measurement may include a measurement of an RSRP, an RSRP, an RSSI, etc. performed by a WTRU of a cell, beam, set of cells, or set of beams. Such L1 measurement(s) may be similar to L3 measurement(s) reported in RRM, with differences in the filtering, reference signals measured, reporting mechanisms, etc.

Measurements may refer to L1 measurements for LTM. However, certain examples may apply (e.g., may also apply) to RRM/L3 measurements, as well as other measurements (e.g., measurements of speed, location, height, traffic, etc.).

LTM cell switch may refer to L1/2 triggered mobility whereby a preconfigured RRC configuration is applied if the WTRU receives an indication using MAC CE or if a certain condition is met at the WTRU. Examples may apply (e.g., may also apply) to an RRC reconfiguration, an RRC conditional reconfiguration, as well as any other type of mobility procedure.

Configurations herein may be provided by an upper (e.g., RRC) layer which may apply to multiple target cells, beams, or TRPs and the lower layer (e.g., MAC, L1) which may control switching between the configurations.

The gNB (e.g., a CU in case of CU/DU split architecture, RRC resides in CU) may configure potential LTM candidate(s) using RRC signaling. In examples, the WTRU may receive the LTM candidate configuration(s) using an RRC Reconfiguration message, for example, during the LTM preparation phase as shown in FIG. 2. The WTRU may store the LTM candidate configuration(s) to later apply if receiving an indication using L1/2 signaling (e.g., via MAC CE) to perform a cell switch, for example, in the LTM execution phase as shown in FIG. 2.

In examples, the configuration of potential LTM candidate(s) may include candidate sets. For example, a first set which may be suitable for a first path (e.g., a WTRU turns left and takes first road) and a second set which may be suitable for a second path (e.g., a WTRU turns right and takes second road).

In examples, some or all of the candidate set information may be broadcasted in system information, and the WTRU may enable the pre-configuration of these broadcast configurations if receiving an indication in dedicated signaling (e.g., via RRC reconfiguration) which may refer to the broadcast one or more configurations (e.g., using an index or identifier).

In examples, the configuration may include all or a subset of the potential cells in a specific area (e.g., all cells belonging to the CU with which the WTRU is currently connected or cells within a particular geographical area). These cells may not yet have been detected or measured by the WTRU, but may be configured in advance. For example, after the initial configuration of LTM candidate configurations, the WTRU may receive an update to the configuration to modify, add, remove, or replace any part of the LTM candidate configuration(s).

In examples, the WTRU may receive an indication to enable or disable some or all of the LTM configurations. For example, if it is predicted that the WTRU mobility would be better handled using L3 (e.g., RRC measurement report, RRC reconfiguration, conditional reconfiguration) then LTM may be disabled. If it is predicted that LTM would better suit the WTRU mobility, then LTM may be enabled (e.g., a previously configured and disabled LTM configuration may be re-enabled).

The configuration may be based on a prediction model internal to, and determined by, the network (e.g., gNB). This prediction may, for example, be based on what the network prediction model determines to be the most likely paths of the WTRUs.

In examples, the candidate cell configuration(s) may include all or part of the information necessary to complete a reconfiguration (e.g., handover) to the candidate cell, such as channel configuration(s) (e.g., PRACH, DPCCH, DPSCH), CORESET, BWP, security parameters, L2 parameters (e.g., MAC, RLC, PDCP), radio bearer configurations, etc.

LTM execution trigger may refer to a condition for performing LTM (e.g., a conditional handover trigger or measurement report trigger), which may be either configured or indicated by the network to the WTRU or estimated/determined by the WTRU.

A trigger may be based on at least one of the following: time; radio quality measurement or predicted radio quality of one or more of the serving cells or target cells; position; an L3 measurement event (e.g., a beam level measurement condition); an L1 measurement event or condition (e.g., a beam level measurement condition); a time or location based condition; a combination of L3, L1, time, and location-based conditions/events; a predicted event; an explicit indication from the network; a measured, predicted, or estimated throughput, error rate, buffer status, or QoS parameter; or an evaluation metric.

For time, the time may be an absolute or relative time measured time at the WTRU, an SFN, or a subframe number.

For the radio quality measurement or predicted radio quality of one or more of the serving cells or target cells, the measurements may include RSRP (beam or cell), RSRQ (beam or cell), cri-RI-PMI-CQI, cri-RI-i1, cri-RI-i1-CQI, cri-RI-CQI, cri-RSRP, ssb-Index-RSRP, or cri-RI-LI-PMI-CQI.

For position, the position may include an area (e.g., defined by reference point and radius), a range of coordinates, or a distance threshold from a reference location.

For the L3 measurement event (e.g., a beam level measurement condition), the L3 measurement event may include one or more of: an event A1 (serving becomes better than threshold); an event A2 (serving becomes worse than threshold); an event A3 (neighbor becomes offset better than SpCell); an event A4 (neighbor becomes better than threshold); an event A5 (SpCell becomes worse than threshold1 and neighbor becomes better than threshold2); an event A6 (neighbor becomes offset better than SCell); an event B1 (inter RAT neighbor becomes better than threshold); or an event B2 (PCell becomes worse than threshold1 and inter RAT neighbor becomes better than threshold2).

For the L1 measurement event or condition (e.g., a beam level measurement condition, or any event defined which utilizes L1 beam measurements to evaluate whether a condition is met), the L1 measurement event or condition may include one or more of: an event LTM1 (beam of serving cell becomes better than absolute threshold); an event LTM2 (beam of serving cell becomes worse than absolute threshold); an event LTM3 (beam of candidate cell becomes amount of offset better than beam of serving cell); an event LTM4 (beam of candidate cell becomes better than absolute threshold); or an event LTM5 (beam of serving cell becomes worse than absolute threshold1 and beam of candidate cell becomes better than another absolute threshold2).

For the time or location-based condition, the time or location-based condition may include a time measured at a WTRU that is within a duration from a threshold; a distance between a WTRU and a referenceLocation1 that is above a threshold1 and a distance between a WTRU and a referenceLocation2 that is below a threshold2; or a distance between a WTRU and the serving cell moving reference location that is above a threshold1 and a distance between a WTRU and a moving reference location that is below a threshold2.

For any combination of L3, L1, time, location-based conditions or events, the combination(s) may include at least one of: a time measured at a WTRU that is within a duration from threshold and a beam of a candidate cell that becomes better than absolute threshold, etc.; a distance between a WTRU and a referenceLocation1 that is above a threshold1 and distance between a WTRU and a referenceLocation2 that is below a threshold2 and a beam of a candidate cell that becomes an amount of offset better than a beam of a serving cell; or a distance between a WTRU and a serving cell moving reference location that is above a threshold1 and a distance between a WTRU and a moving reference location that is below a threshold2 and a beam of a serving cell that becomes worse than an absolute threshold1 and a beam of a candidate cell that becomes better than another absolute threshold2.

For the predicted event, the predicted event may use any of the measurement quantities previously used for measuring or predicting CSI information.

For the explicit indication from the network, the WTRU may enable CSI reporting based on an explicit indication (e.g., via a MAC CE) received from the network. The WTRU may (e.g., may then) execute LTM cell switch if receiving a second MAC CE from the network.

For the evaluation metric, the evaluation metric may include one or more of: a time-to-trigger, a hysteresis, an offset (e.g., a radio quality measurement offset), or a measurement filtering configuration.

The trigger may include one or more conditions under which the WTRU is allowed to perform any action related to LTM. For example, the WTRU may perform one or more of the following procedures: an early TA acquisition; switching off CSI reporting; switching on or updating the CSI reporting configuration; performing an LTM cell switch; monitoring PDCCH on a target cell; performing beam failure recovery (BFR) or radio link monitoring (RLM) on a target cell; or activating or deactivating certain cells.

For early TA acquisition, the WTRU may trigger a RACH to a target LTM cell. For example, the WTRU may receive a TA value in a RAR. The RAR may come from target cell, or via source cell. For example, the WTRU may receive a TA value in a MAC CE triggering the cell switch. For example, the WTRU may perform power ramping and preamble retransmission on the target cell if a RAR/MAC CE is not received. For early TA acquisition, the WTRU may acquire the TA value of a candidate LTM cell by a measurement and trigger the LTM when complete. The WTRU may support and be configured with WTRU-based TA measurement, whereby the WTRU may acquire the TA value(s) of the candidate cell(s) by measurement.

For switching off CSI reporting, the WTRU may be allowed to (e.g., or may be required to) switch off CSI reporting in order to reduce reporting overhead in the uplink. The CSI reporting may be reduced rather than switched off. For example, a number of cells or beams reported may be reduced, or the frequency of reporting may be reduced. For switching off CSI reporting, the WTRU may resume CSI reporting if the condition is no longer met.

For switching on or updating the CSI reporting configuration, the WTRU may be required to perform and report CSI measurements on one or a subset of LTM candidate cells during the window.

For performing LTM cell switch, there may be condition(s) under which the WTRU is allowed to trigger LTM cell switch.

For monitoring PDCCH on a target cell (e.g., NTN candidate cell), the WTRU may be configured to monitor on a target cell for a DCI scheduling PDSCH or indicating one or more actions on the target cell (e.g., to initiate the cell switch procedure).

For performing BFR or RLM on a target cell (e.g., NTN candidate cell), the WTRU may be configured to monitor beam failure detection (BFD) resources on a target cell or may perform radio link monitoring (RLM) on a target cell during the window.

For activating or deactivating certain SCells, the WTRU may be configured with one or more specific SCells which may be active or not active during the window.

To support LTM based satellite switch early uplink synchronization, the WTRU may receive assistance information and/or configuration(s) from the network. The assistance information and/or configuration(s) may be explicitly provided via dedicated signaling (e.g., via RRC signaling, MAC CE, or DCI), broadcasted in system information, or both. For example, the WTRU may receive some assistance information such as LTM cell switch time and information related to neighbor satellite position in a broadcast manner, but may receive configuration(s) for timing advance calculation, measurement reporting, resynchronization gap configuration, power control, and/or beam management in a dedicated manner (e.g., via RRC). The WTRU may be required (e.g., via configuration) to receive and maintain updated system information at some time prior to LTM cell switch to minimize the risk of synchronization failure and ensure that the necessary information is available at time of LTM cell switch. WTRU configuration(s)/assistance information provided in a dedicated manner may override assistance information received via broadcast indication.

For example, the WTRU may receive one or more of the following assistance information and/or configuration(s) to support LTM cell switch early uplink synchronization: the time of LTM cell switch. (e.g., 10:31:20 UTC time); the location of the incoming satellite at time of LTM cell switch; the location of the former satellite at time of LTM cell switch; ephemeris data of the incoming satellite (e.g., to support WTRU prediction of the incoming satellite location at the time of LTM cell switch); ephemeris data of the former satellite (e.g., to support WTRU prediction of the former satellite location at the time of LTM cell switch); common time information (e.g., the feeder-link delay, kmac) for the incoming satellite and/or former satellite (e.g., at the time of LTM cell switch); information and/or configuration(s) to support pre-calculation and reporting of timing advance to the incoming satellite; information and/or configuration(s) to support radio-link monitoring; information and/or configuration(s) to a resynchronization gap and a RX/TX suspension; information and/or configuration(s) to support WTRU autonomous UL power adjustment; information and/or configuration(s) to support beam management; information and/or configuration(s) to support uplink synchronization status indication.

A WTRU may request assistance information to support early uplink synchronization to an incoming satellite during LTM. A WTRU may trigger a request, for example, if the WTRU was unable to acquire one or more information fields necessary to complete resynchronization prior to an LTM cell switch. The WTRU may trigger a request for assistance information, for example, if a connection is established (e.g., upon initial access, service resumption) or mobility is established.

The request for assistance information may be sent via UCI, SR, RACH messaging (e.g., MSGA, MSG3, MSG5), PUSCH, MAC CE, and/or RRC signaling. The assistance information request may include a general request (e.g., a flag indicating requesting all available information) or may indicate one or more specific information fields to be provided to the WTRU.

To enable RACH-less handover, whereby the WTRU may not be required to send a random access preamble or perform a random access procedure on the target cell following a reconfiguration trigger, but rather the WTRU performs PDCCH reception and uplink transmission using the TA already provided, the WTRU may perform an early TA acquisition procedure with candidate cell(s) before receiving the cell switch command or before triggering a conditional reconfiguration.

The WTRU may experience a large difference in timing advance when the LTM based satellite switch occurs. In legacy, the WTRU may calculate a TA value via ephemeris prior to (e.g., only prior to) RACH, so a large timing advance difference at time of an LTM based satellite switch (e.g., which may not require RACH) may cause TA synchronization failure. For LTM in a TN, the TA is typically determined by the source cell sending a PDCCH order to the WTRU, which may trigger the WTRU to send a random-access preamble to the target cell. The target cell may calculate the TA value and may provide the TA value to the source cell. The source cell may (e.g., may then) include the TA value in a cell switch MAC CE, and the WTRU may apply this value when sending the first uplink transmission to the target cell following handover. For NTN, long transmission delay may mean that the calculated TA at the target cell may take a long time to be transmitted back via the source cell to the WTRU. This may mean that the value may be outdated, or the early synchronization procedure may take too long to support low latency mobility. Uplink coverage may be an issue in addition to long transmission delay, and RA may not be reliable requiring several retransmissions (e.g., even if performed at full transmission power).

A WTRU may pre-calculate the timing advance to an incoming satellite at the time of LTM cell switch (e.g., to enable fast timing synchronization to an incoming satellite after LTM cell switch). The network may control (e.g., enable/disable) the WTRU ability to pre-calculate a timing advance via an explicit RRC configuration, via an indication in broadcast signaling, and/or via a (de) activation command (e.g., via a MAC CE). The network may configure a window (e.g., a time period) or offset from the LTM cell switch for the WTRU to pre-calculate the timing advance. If the WTRU is unable to determine the future timing advance by expiration of this time period (e.g., or by an indicated time), the WTRU may not pre-calculate the timing advance. If timing advance pre-calculation is enabled and the WTRU is unable to perform the pre-calculation, the WTRU may send a report or indication to the network.

To support timing advance pre-calculation, the WTRU may use assistance information about the incoming satellite to determine the common timing information (e.g., feeder-link delay) and the location of the satellite at the time of LTM cell switch. This information may be the explicit position of the satellite at the time of LTM cell switch. The WTRU may use ephemeris data of incoming satellite to predict the location of satellite at the time of LTM cell switch. The WTRU may (e.g., may then) acquire its location (e.g., via GNSS) and calculate the distance between the WTRU and incoming satellite at time of LTM cell switch. Using this distance to estimate the service link delay, the WTRU may (e.g., may then) add the common timing information from the incoming satellite to determine the full timing advance between the WTRU and incoming satellite at time of LTM cell switch. The WTRU may (e.g., may then) store the pre-calculated value to be applied for subsequent UL transmission(s) at and/or after a time of an LTM cell switch (e.g., or some other explicitly indicated time).

In examples of timing advance pre-calculation, the WTRU may be requested and/or triggered (e.g., at some offset prior to LTM cell switch) to report the WTRU location (e.g., or an estimated WTRU location at the time of a satellite switch) for the network to calculate the WTRU timing advance. The network may (e.g., may subsequently) provide a timing advance command with an associated activation time (e.g., the LTM cell switch). The WTRU may apply the timing advance value to transmission(s) occurring after the activation time.

If the WTRU has pre-reported the timing advance value, the WTRU may receive additional timing advance adjustments from the network prior to satellite switch. The network may explicitly indicate whether a timing advance command is for the current timing advance (e.g., to the former satellite) or for the future timing advance (e.g., to the incoming satellite).

A WTRU may be provided with two types of ephemeris information for determining timing advance values. A first type of ephemeris information may be used to determine one or more transmission parameters (e.g., WTRU-specific and/or cell-specific timing advance value, K_offset, K_mac) for a current uplink transmission (e.g., or a first time window). A second type of ephemeris information may be used to determine one or more transmission parameters for a future uplink transmission (e.g., or a second time window). The first type of ephemeris information may be associated with current satellite and the second type of ephemeris information may be associated with incoming satellite. The second type of ephemeris information may be provided by the current satellite. One or more ephemeris information may be configured or provided to a WTRU (e.g., via a higher signaling) and ephemeris information (e.g., each ephemeris information) may be indicated or associated with timing information (e.g., validity timer, time stamp, validity duration, starting time, start/end time),

A WTRU may report the pre-calculated timing advance to the incoming satellite ahead of the LTM cell switch. WTRU timing advance pre-reporting (pre-TAR) may be subject to a configuration, which may include one or more of the following: an enable/disable indication; an offset from the LTM cell switch time to perform the pre-TAR; a window (e.g., time period) to report the pre-TAR; resources (e.g., an UL scheduling grant) to report pre-TAR; or which information fields to include within a pre-TAR (e.g., service link TA vs. full TA).

In examples, WTRU may pre-report a timing advance to the incoming satellite if a valid configuration is provided and/or if receiving an explicit network request. In examples, the WTRU may (e.g., may only) report the timing advance value ahead of time subject to one or more pre-configured conditions. For example, if the difference in timing advance between the former and incoming satellite is larger than a threshold, the WTRU may transmit a pre-TAR.

If timing advance pre-reporting is enabled and all configured conditions are satisfied, the WTRU may trigger a transmission of a pre-TAR. A pre-TAR may include one or more of the following: an explicit indication that the TAR corresponds to a future timing advance value (e.g., to the incoming satellite at time of LTM cell switch); the absolute timing advance value corresponding to the full WTRU-gNB timing advance; the absolute timing advance value for the service link (e.g., WTRU-incoming satellite timing delay); the delta from the currently applied timing advance (e.g., to the former satellite); information used to pre-calculate the timing advance (e.g., the location and timing information of the incoming satellite); or a WTRU estimate of when the WTRU will be time synchronized (e.g., when the WTRU applies the timing advance value to subsequent UL transmission(s)).

At time of an LTM cell switch (e.g., or some explicitly indicated activation time), the WTRU may apply the pre-calculated timing advance value and may use the value for subsequent transmission(s). If the WTRU is configured with offsetThresholdTA, and the application of the new timing advance value triggers a timing advance report, the WTRU may ignore the TAR trigger (e.g., the WTRU may not trigger TAR and may send an updated report) if the WTRU has already pre-reported the timing advance value to the incoming satellite. For example, the WTRU may (e.g., may only) ignore the trigger subject to confirmation that the pre-reported timing advance value has been successfully received. The WTRU may assume successful reception based on reception of HARQ-ACK.

The WTRU may perform beam refinement on a target cell before or during a handover and before the WTRU accesses the target cell, such that a WTRU may first perform measurement of SSB resources then select a subset of CSI-RS resources to measure based on the SSB measurement(s) (e.g., based on the best SSB measured). The WTRU may (e.g., may then) perform measurement(s) on the selected subset of CSI-RS resource and determine a best CSI-RS resource. The selected best CSI-RS resource may be indicated before a handover takes place (e.g., to a source cell) or if initially accessed (e.g., to a target cell), rather than performing the beam refinement only after a connection to a target cell is completed.

The WTRU may report the measurements of the subset of CSI-RS resources using CSI reporting on a PUCCH to the source cell. The report may be transmitted using a MAC CE or an RRC measurement report, or any other type of uplink signaling. The report may include one or more of: a RSRP (beam or cell); a RSRQ (beam or cell); a cri-RI-PMI-CQI; a cri-RI-i1; a cri-RI-i1-CQI; a cri-RI-CQI; a cri-RSRP; an ssb-Index-RSRP; or a cri-RI-LI-PMI-CQI.

The WTRU may determine, based on a trigger, a subset of CSI-RS to measure. For example, the WTRU may determine based on a pre-configured association (e.g., configured by RRC) between an SSB and CSI-RS resources. The WTRU may determine based on an indication of an SSB or determining a best SSB from performed SSB measurement(s).

The subset of CSI-RS may be indicated explicitly in a random-access response (e.g., using a pointer to one of multiple subsets) or may be indicated implicitly (e.g., the WTRU may enable a subset of CSI-RS depending on a reported or indicated SSB when the RAR is received). The WTRU may enable the subset of CSI-RS measurements if the WTRU receives a PDCCH order triggering early TA acquisition, while the RAR or MAC CE includes a TA in response to the PRACH preamble transmission for a TA acquisition activating the configured grant.

The CSI-RS measurement(s) may be configured temporarily. For example, the WTRU may activate CSI-RS measurement(s) for a certain time period, or for a certain number of reports, which may be configured or predefined. The WTRU may deactivate CSI-RS measurement(s) if a best SSB changes, or if an SSB or CSI-RS measurement goes below a threshold.

The WTRU may receive an indication to activate a grant from either a source or a target cell. This may be: a type 2 configured grant, whereby the first cell may configure the grant and the second cell may activate the grant; an explicit grant (e.g., a direct indication of the grant to use); or a pointer to one or more preconfigured grants (e.g., previously configured by RRC). An indication of the grant may be a pointer to a configured grant corresponding to a reported SSB, or may be a set of configured grants corresponding to multiple CSI-RS associated with a reported SSB. The configured grant activation may be received in a PDCCH order (e.g., triggering TA acquisition), in a MAC CE (e.g., triggering LTM), or in a RAR (e.g., received from the source or the target, including a TA value to use for RACH-less handover). The WTRU may autonomously activate a configured grant based on a condition (e.g., any of the LTM execution triggers as provided herein).

A cell switch command may be received in a downlink signal such as DCI or MAC CE. This cell switch command may be received from a source cell or from a target cell (e.g., a cell determined to be the best cell). In examples, if a hyper cell is used, the cell may be switched without notifying the WTRU. Instead, the network may configure, based on uplink measurements, to use a new TRP with the same configuration as the previous one. In examples, an uplink and a downlink connection may be separately managed. For example, mobility based on reported downlink measurement(s) may be used to manage downlink channel(s) and TRP(s), while the network may select uplink channel(s) and TRP(s) based on uplink measurement signal(s).

Examples of LTM in NTNs are provided herein. Examples of enabling mobility controlled by the DU on board a satellite by optimizing LTM for NTN are provided herein. LTM based L1 measurement reporting and/or conditional LTM may be enabled by introducing time and location-based events to the beam level L1 reporting/evaluation framework. A WTRU may be enabled to perform location-based NTN configuration. The WTRU may dynamically indicate when to perform procedure using a MAC CE/PDCCH order.

In examples, a WTRU may be initially connected to a terrestrial cell. A WTRU may receive an RRC configuration (e.g., configuration information) of one or more LTM candidate cells. The configuration information may include an indication (e.g., a first indication) of cell type (e.g., an LTM candidate cell type) being an NTN cell. The configuration information may include associated ephemeris information or further ephemeris information (e.g., which may include the LTM candidate cell type being an NTN cell). The configuration information may (e.g., may also) include an indication (e.g., a fourth indication) configuring a TA acquisition type as location-based timing pre-compensation. The configuration information may (e.g., may also) include an indication (e.g., a fifth indication) of a satellite architecture type. Based on the satellite architecture type, a TA estimate may include the WTRU to satellite path (e.g., if full gNB on board), or may include satellite to ground (e.g., transparent architecture).

The WTRU may receive a measurement configuration (e.g., configuration information) including at least one L1 beam level measurement condition associated with the one or more NTN LTM candidate cells. The measurement configuration information may (e.g., may also) include at least one measurement event condition associated with the NTN candidate cell including one or more of the following: an LTM measurement event which uses a time-based triggering condition; or an LTM measurement event which uses a distance-based triggering condition.

The time-based triggering condition may be a time measured at the WTRU that is within a duration from a threshold. The distance-based triggering condition may be the distance between the WTRU and a referenceLocation1 being above a threshold1 and the distance between the WTRU and a referenceLocation2 being below a threshold2. The distance-based triggering condition may be the distance between the WTRU and the serving cell moving reference location being above a threshold1 and distance between the WTRU and a moving reference location being below a threshold2.

The WTRU may trigger an LTM event based on at least one measurement event condition being satisfied (e.g., the time and/or distance-based condition being met) and the beam level measurement condition being satisfied.

Based on the LTM event being triggered, the WTRU may perform an action. The action may include one or more of the following: a transmission of a measurement report using a MAC CE or a PUCCH that indicates at least that at the least one measurement condition being satisfied (e.g., a time/distance/beam measurement condition being met); a determination of the TA value for the NTN candidate cell using an early synchronization procedure; a performance of a conditional LTM to the target cell (e.g., NTN candidate cell); or a determination to update the NTN candidate cell. For the transmission using a MAC CE or a PUCCH that indicates at least that at the least one measurement condition being satisfied (e.g., a time/distance/beam measurement condition being met), the WTRU may (e.g., may then) receive the cell switch MAC CE or the PDCCH order for early UL synchronization.

For the determination of the TA value for the NTN candidate cell using an early synchronization procedure, the WTRU may transmit a RA to a target cell (e.g., NTN candidate cell) and/or may perform location-based timing pre-compensation (e.g., the WTRU may then continue the LTM procedure).

For the performance of the LTM (e.g., performance of the conditional LTM to the NTN target cell), the performance may be RACH-less or RACH based.

For the determination (e.g., based on the time and/or distance-based condition being met) to update the NTN candidate cell (e.g., active NTN LTM candidate cell(s)), updating the NTN candidate cell may be used to perform at least one of: may be used to enable/disable certain measurements/RSs/NTN cells; may be used to release a candidate configuration (e.g., an NTN candidate cell configuration); or may be used to enable or disable a specific measurement event or conditional LTM configuration (e.g., enable or disable at least one measurement event condition).

The WTRU may receive an indication (e.g., a second indication) to perform location-based timing pre-compensation associated with one or more NTN candidate cells. In examples, the indication to perform location-based timing pre-compensation associated with one or more NTN candidate cells may be based on at least one measurement event condition being satisfied. In examples, the indication to perform location-based timing pre-compensation associated with one or more NTN candidate cells may be explicitly triggered. In examples, the indication to perform location-based timing pre-compensation may be indicated via a PDCCH order (e.g., a PDCCH order may be used to trigger a RA to a target cell). In examples, the indication to perform location-based timing pre-compensation may be indicated via a MAC CE (e.g., the TA value may be included within a cell switch MAC CE or may be included within a separate MAC CE). In examples, the indication to perform location-based timing pre-compensation may indicate, in the MAC CE or RRC configuration, a time at which to apply the cell switch and may calculate a TA value according to that time.

The WTRU may determine a TA value (e.g., a first TA value) associated with the indicated NTN candidate cell(s) based on (e.g., using) the location-based timing pre-compensation. In examples, the WTRU may indicate a completion of TA acquisition to source (e.g., using a MAC CE). In examples, the WTRU may determine a validity time for the TA value (e.g., may start a timer).

The WTRU may receive an indication (e.g., third indication) to perform LTM to the NTN candidate cell (e.g., via a cell switch MAC CE). The indication (e.g., third indication) may indicate which TA value to use (e.g., an explicit TA value via a MAC CE or a RRC configured type TA value (e.g., the RRC configuration value may be the TA value associated with the indicated NTN candidate cell(s) based on the location-based timing pre-compensation, if available). In examples, the indication (e.g., third indication) to perform LTM to the NTN candidate cell may be based on at least one measurement event condition being satisfied. In examples, the indication to perform LTM to the NTN candidate cell associated with one or more NTN candidate cells may be explicitly triggered.

The WTRU may perform the LTM to the NTN candidate cell. In examples, the performance of the LTM to the NTN candidate cell may include an execution of a handover to the NTN candidate cell. Based on the first TA value (e.g., associated with the NTN candidate cell and/or target cell) being valid (e.g., based on timer), the WTRU may transmit a handover completion message (e.g., a RRC reconfiguration complete message on PUSCH) using the first value TA (e.g., the TA value determined using the location-based timing pre-compensation procedure). Based on the first TA value (e.g., associated with the NTN candidate cell and/or target cell) being invalid, the third indication may indicate a second TA value to use and the WTRU may transmit a handover completion message (e.g., a RRC reconfiguration complete message on PUSCH) to the target cell using the second TA value. In examples, the transmission of the handover complete message may be RACH-less using either a configured grant or scheduled grant (e.g., received by monitoring a PDCCH if a cell switch occurs).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU), comprising:
a processor configured to:
receive radio resource control (RRC) configuration information, wherein the RRC configuration information includes:
a first indication comprising a cell type indicating a non-terrestrial network (NTN) candidate cell, and
associated ephemeris information or further ephemeris information;
receive measurement configuration information, wherein the measurement configuration information includes:
a beam level measurement condition associated with the NTN candidate cell, and
at least one measurement event condition associated with the NTN candidate cell including at least one of a time-based triggering condition or a distance-based triggering condition;
trigger an L1/L2 triggered mobility (LTM) event based on the beam level measurement condition and the at least one measurement event condition being satisfied;
perform an action based on the LTM event being triggered;
receive a second indication to determine a location-based timing pre-compensation associated with the NTN candidate cell;
determine a timing advance (TA) value associated with the NTN candidate cell based on the determined location-based timing pre-compensation;
receive a third indication to perform LTM to the NTN candidate cell; and
perform the LTM to the NTN candidate cell and transmit, using the TA value, a handover completion message to the NTN candidate cell.

2. The WTRU of claim 1, wherein:
the TA value is a first TA value, and
the transmission of the handover completion message to the NTN candidate cell uses the first TA value based on the first TA value for the NTN candidate cell being valid.

3. The WTRU of claim 1, wherein:
the TA value is a first TA value,
the third indication indicates a second TA value to use on a condition that the first TA value for the NTN candidate cell is invalid, and
the transmission of the handover completion message to the NTN candidate cell uses the second TA value.

4. The WTRU of claim 3, wherein the RRC configuration information further includes:
a fourth indication that configures a TA acquisition type as the location-based timing pre-compensation, and
a fifth indication of a satellite architecture type.

5. The WTRU of claim 1, wherein the action performed based on the LTM event being triggered is at least one of:
a transmission of a measurement report using a medium access control (MAC) control element (CE) transmission or a physical uplink control channel (PUCCH) transmission that indicates the at least one measurement event condition being satisfied,
a determination of the TA value for the NTN candidate cell using an early synchronization procedure,
a performance of a conditional LTM to the NTN candidate cell, or
a determination to perform an update associated with the NTN candidate cell.

6. The WTRU of claim 5, wherein the update associated with the NTN candidate cell is used to perform at least one of:
enabling or disabling a measurement,
releasing a configuration of the NTN candidate cell, or
enabling or disabling the at least one measurement event condition.

7. The WTRU of claim 1, wherein the second indication to perform location-based timing pre-compensation for the NTN candidate cell indicates a time to apply a cell switch and to calculate the TA value based on the time to apply a cell switch.

8. The WTRU of claim 1, wherein the processor is further configured to:
indicate a completion of a TA acquisition to a source cell; and
determine a validity time associated with the TA value, wherein the LTM is performed to the NTN candidate cell based on a condition that the validity time has not expired.

9. The WTRU of claim 1, wherein the handover completion message is an RRC reconfiguration complete message.

10. The WTRU of claim 1, wherein the performance of the LTM to the NTN candidate cell comprises an execution of a handover to the NTN candidate cell.

11. A method associated with a wireless transmit/receive unit (WTRU), comprising:
receiving radio resource control (RRC) configuration information, wherein the RRC configuration information includes:
a first indication comprising a cell type indicating a non-terrestrial network (NTN) candidate cell, and
associated ephemeris information or further ephemeris information;
receiving measurement configuration information, wherein the measurement configuration information includes:
a beam level measurement condition associated with the NTN candidate cell, and
at least one measurement event condition associated with the NTN candidate cell including at least one of a time-based triggering condition or a distance-based triggering condition;
triggering an L1/L2 triggered mobility (LTM) event based on the beam level measurement condition and the at least one measurement event condition being satisfied;
performing an action based on the LTM event being triggered;
receiving a second indication to determine a location-based timing pre-compensation associated with the NTN candidate cell;
determining a timing advance (TA) value associated with the NTN candidate cell based on the determined location-based timing pre-compensation;
receiving a third indication to perform LTM to the NTN candidate cell; and
performing the LTM to the NTN candidate cell and transmit, using the TA value, a handover completion message to the NTN candidate cell.

12. The method of claim 11, wherein:
the TA value is a first TA value, and
the transmission of the handover completion message to the NTN candidate cell uses the first TA value based on the first TA value for the NTN candidate cell being valid.

13. The method of claim 11, wherein:
the TA value is a first TA value,
the third indication indicates a second TA value to use on a condition that the first TA value for the NTN candidate cell is invalid, and
the transmission of the handover completion message to the NTN candidate cell uses the second TA value.

14. The method of claim 13, wherein the RRC configuration information further includes:
a fourth indication that configures a TA acquisition type as the location-based timing pre-compensation, and
a fifth indication of a satellite architecture type.

15. The method of claim 11, wherein the action performed based on the LTM event being triggered is at least one of:
a transmission of a measurement report using a medium access control (MAC) control element (CE) transmission or a physical uplink control channel (PUCCH) transmission that indicates the at least one measurement event condition being satisfied,
a determination of the TA value for the NTN candidate cell using an early synchronization procedure,
a performance of a conditional LTM to the NTN candidate cell, or
a determination to perform an update associated with the NTN candidate cell.

16. The method of claim 15, wherein the update associated with the NTN candidate cell is used to perform at least one of:
enabling or disabling a measurement,
releasing a configuration of the NTN candidate cell, or
enabling or disabling the at least one measurement event condition.

17. The method of claim 11, wherein the second indication to perform location-based timing pre-compensation for the NTN candidate cell indicates a time to apply a cell switch and to calculate the TA value based on the time to apply a cell switch.

18. The method of claim 11, further comprising:
indicating a completion of a TA acquisition to a source cell; and
determining a validity time associated with the TA value, wherein the LTM is performed to the NTN candidate cell based on a condition that the validity time has not expired.

19. The method of claim 11, wherein the handover completion message is an RRC reconfiguration complete message.

20. The method of claim 11, wherein the performance of the LTM to the NTN candidate cell comprises an execution of a handover to the NTN candidate cell.
